(19) United States
(12) Patent Application Publication
(10) Pub. No.: US 2026/0250111 A1
(43) Pub. Date: Aug. 27, 2026

(54) Wear Pad Assembly

(71) Applicant: Caterpillar, Inc., Peoria, IL (US)

(72) Inventor: Robin Jonathan HOLDEN, Leicestershire (GB)

(73) Assignee: Caterpillar, Inc., Peoria, IL (US)

(21) Appl. No.: 18/992,110

(22) PCT Filed: Jun. 27, 2023
(86) PCT No.: PCT/US2023/069183

§ 371 Date: Jan. 7, 2025

(30) Foreign Application Priority Data
Jul. 8, 2022 (GB) 2210095.2

(51) Int. Cl. B66F 9/075

(52) U.S. Cl. CPC B66F 9/075

(57) ABSTRACT

The present disclosure is directed towards a wear pad assembly for an extendable boom having a first boom section and a second boom section. The wear pad assembly comprises a base plate for mounting to the first boom section the base plate comprising one or more locating protrusions. The wear pad assembly (20) further comprises a wear pad having a thickness extending between a coupling surface and an opposing sliding surface The coupling surface comprises a recess for engagement with the one or more locating protrusions of the base plate. The recess is configured to provide a clearance fit with the one or more locating protrusions of the base plate.

### TECHNICAL FIELD

This disclosure is directed towards a wear pad assembly for an extendable boom, and a machine or telehandler comprising such a wear pad.

### BACKGROUND

Machines such as telehandlers (also known as telescopic handlers or roto telehandlers) typically comprise a lifting arm. These lifting arms are used to lift, carry and place materials around construction sites, agricultural sites and the like. The lifting arm typically comprises an extendable boom or telescopic cylinder to which a work tool, such as a fork or bucket, can be attached. The extendable boom comprises a main boom section attached to the main body of the telehandler via a hinge, and a telescopic boom section mounted in the main boom section. The telescopic boom section is slidable along the main boom section between retracted and extended orientations. The telehandler may have further telescopic boom sections mounted within the telescopic boom section.

One or more sacrificial and replaceable wear pads are typically located between two sliding telescopic sections, to prevent wear of the telescopic sections, to reduce friction, and to take up gaps between the telescopic sections. Due to variation in fabrication tolerances, shims are commonly used to achieve desired wear pad running clearances between sliding telescopic sections. Shims may also be used to maintain desired running clearances during the lifetime of a wear pad, thereby prolonging the lifetime of the wear pad. JP-Y2-H0649581 discloses a wear pad assembly that uses shims to adjust a gap between the telescopic sections.

There is an ongoing need to improve the structure of wear pad assemblies for telescopic sections, to increase the ease with which the wear pad assembly can be adjusted. A particular need is to reduce servicing costs, which can be relatively high due to the cost of the skilled labour required in the servicing of telehandlers. Furthermore, many telehandlers are rented to operators and thus reduced service or down time would be particularly beneficial.

### SUMMARY

The present disclosure provides a wear pad assembly for an extendable boom having a first section and a second section, the wear pad assembly comprising: a base plate for mounting to the first section of the extendable boom, the base plate comprising one or more locating protrusions; and a wear pad having a thickness extending between a coupling surface and an opposing sliding surface, the coupling surface comprising a recess for engagement with the one or more locating protrusions of the base plate; wherein the recess is configured to provide a clearance fit with the one or more locating protrusions of the base plate.

Optionally, the recess engages with the one or more locating protrusions such that the wear plate engages with the base plate but is detached from it.

Optionally, the recess is sized and/or shaped to provide the clearance fit with the one or more locating protrusions of the base plate.

Optionally, one or more edges of a perimeter of the sliding surface of the wear pad are provided with a chamfer. Optionally, leading edges of the wear pad relative to a sliding direction of the wear pad are provided with a chamfer.

Optionally, the base plate further comprises a base plate tab extending in a plane of the base plate from a side of the base plate.

Optionally, the base plate further comprises at least one base plate aperture. Optionally, each base plate aperture extends through a locating protrusion of the one or more locating protrusions.

Optionally, the wear pad assembly further comprises one or more shims for positioning between the base plate and the wear pad, each shim comprising a shim aperture for engagement with the one or more locating protrusions of the base plate.

Optionally, the shim aperture is configured to provide a clearance fit with the one or more locating protrusions of the base plate. Optionally, the shim aperture is sized and/or shaped to provide a clearance fit with the one or more locating protrusions of the base plate.

Optionally, each shim comprises a shim tab extending in a plane of the shim from a side of the shim. Optionally, the shim tab is aligned with the base plate tab when the shim is located on the base plate.

The present disclosure further provides an extendable boom having a first section and a second section, the extendable boom comprising the aforementioned wear pad assembly.

Optionally, the wear pad assembly is mounted to the first boom section and the second boom section is configured to slide relative to the first boom section along the sliding surface of the wear pad.

Optionally, the entire wear pad assembly is positioned between the first boom section and the second boom section.

Optionally, the wear pad and the base plate are constrained in a direction perpendicular to a plane of the planar element by the first and second boom sections.

The present disclosure further provides a telehandler comprising the aforementioned extendable boom.

### BRIEF DESCRIPTION OF THE DRAWINGS

Embodiments of the present disclosure will now be described, by way of example only, with reference to the accompanying drawings, in which:

FIG. 1 shows a schematic side elevation of a telehandler comprising a wear pad assembly in accordance with the present disclosure;

FIG. 2 shows an exploded perspective view of a wear pad assembly in accordance with the present disclosure;

FIG. 3 shows a perspective cross-sectional view of the wear pad assembly of FIG. 2, mounted to a first boom section; and

FIG. 4 shows a side view of the wear pad assembly of FIGS. 2 and 3, mounted to a first boom section and facing a second boom section.

### DETAILED DESCRIPTION

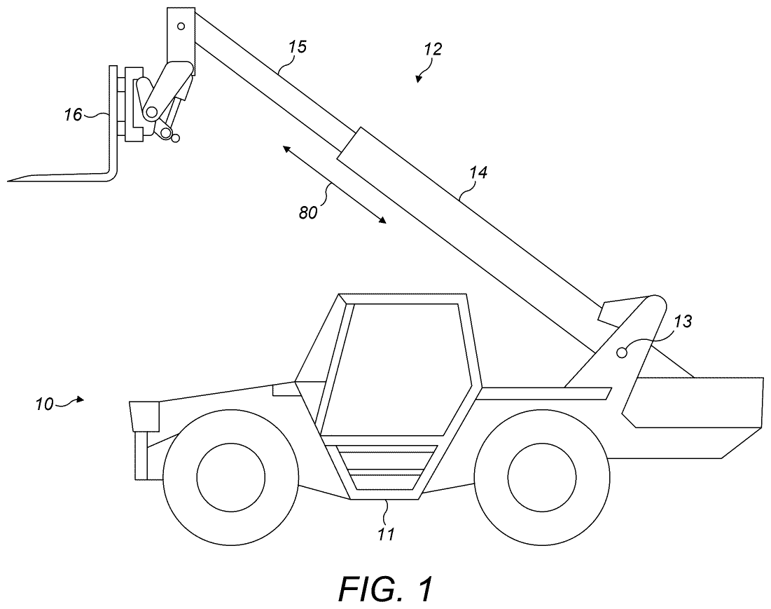

FIG. 1 illustrates a telehandler 10 comprising the wear pad assembly 20 of the present disclosure (not visible in FIG. 1). The telehandler 10, also known as a telescopic handler, may be any type of telehandler, such as a roto or rotating telehandler. The telehandler 10 may comprise a chassis or main body 11 and a boom 12 mounted thereto at a boom hinge 13. The boom 12 may comprise a main boom section 14 and a telescopic boom section 15 mounted to the main boom section 14. The telescopic boom section 15 may be retractably mounted inside the main boom section 14 such that the telescopic boom section 15 is slidable relative to the main boom section 14 along a sliding direction 80. Although not shown in FIG. 1, a further telescopic boom section may be retractably mounted inside the telescopic boom section 15 such that the further telescopic boom section is slidable relative to the telescopic boom section 15 along the sliding direction 80. A work tool 16, in this case a fork, may be attached to the telescopic boom section 15 for performing work.

At least one wear pad assembly 20 may be located between the main boom section 14 and the telescopic boom section 15, such that the boom sections 14,15 may slide relative to one another along a wear pad 40 of the wear pad assembly 20. The at least one wear pad assembly 20 may prevent wear of the boom sections 14,15 from the sliding motion, reduce friction, and increase stability of the boom 12 by taking up gaps between the boom sections 14,15. Typically a plurality of wear pad assemblies 20 may be provided between the boom sections 14,15. For example, for typical square boom sections 14,15, one or more wear pad assembly(ies) 20 may be provided on each of two opposing sides, or even on all four sides, of the main boom section 14 or the telescopic boom section 15. Furthermore, wear pad assemblies 20 may be provided at both upper and lower ends of the boom sections 14,15. The following description in relation to a single wear pad assembly 20 may equally apply to some or all of the other wear pad assemblies 20.

The wear pad assembly 20 may be mounted to the main boom section 14 such that the telescopic boom section 15 slides along it, or the wear pad assembly 20 may be mounted to the telescopic boom section 15 such that the main boom section 14 slides along it. The boom section 14,15 to which the wear pad assembly 20 is mounted will be referred to herein as the first boom section 21 and the boom section 14, 15 that slides along the wear pad assembly 20 will be referred to herein as the second boom section 22. There may be no contact between the boom sections 14, 15 during extension and retraction other than via the wear pad assembly(ies) 20.

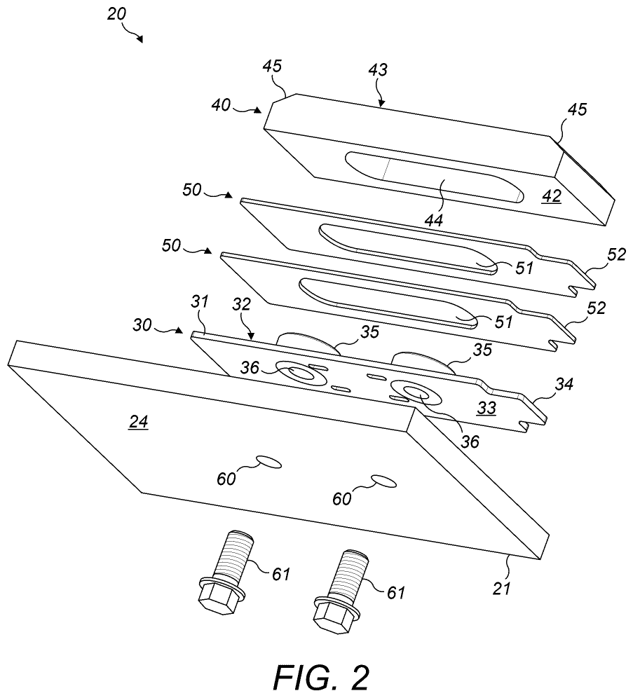

As shown in FIGS. 2 to 4, the wear pad assembly 20 generally comprises a base plate 30 and a wear pad 40. The wear pad assembly 20 may further comprise one or more shims 50.

The base plate 30 may comprise a planar element 31 having a first surface 32 and an opposing second surface 33, the planar element 31 having a length and a width that are substantially greater than its thickness. The planar element 31 may have a substantially rectangular shape as illustrated. Alternatively, the planar element 31 may have a circular shape, a polygonal shape, or an irregular shape. The planar element 31 may be provided with a base plate tab 34, which may extend in the plane of the planar element 31 from one side of the planar element 31.

At least one locating protrusion 35 may extend from the first surface 32 of the planar element 31, for locating the wear pad 40 and shim(s) 50 on the base plate 30. The locating protrusion 35 may extend substantially perpendicularly from the first surface 32. Any practicable cross-sectional shape may be used for the locating protrusion 35. For example the cross-section of the locating protrusion 35 may have a circular, square, rectangular, triangular, other polygonal, or irregular cross-sectional shape. The locating protrusion may be positioned anywhere on the first surface 32 of the planar element 31, optionally in a generally central location. As shown in the specific embodiment shown in FIGS. 2 to 4, two spaced apart generally circular locating protrusions 35 may be provided.

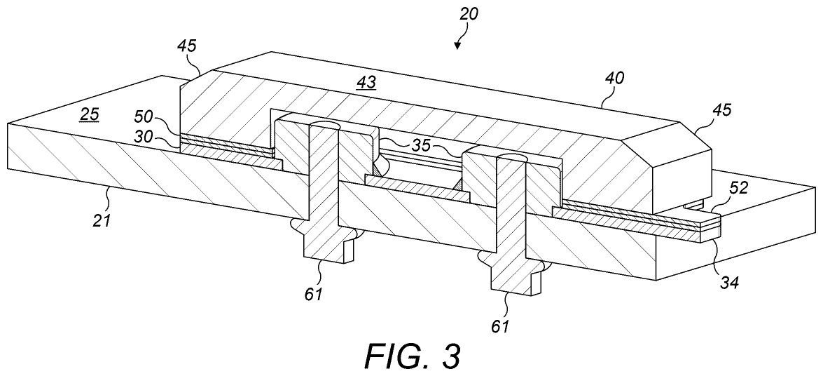

The base plate 30 may be configured to be releasably mounted to the first boom section 21. For example, as shown in FIGS. 2 and 3, the planar element 31 may comprise at least one base plate aperture 36 for receiving a releasable fastener 61. The at least one base plate aperture 36 may be located on the planar element 31 in the region of the at least one locating protrusion 35, such that the base plate aperture 36 may extend through the locating protrusion 35. As shown in the specific embodiment shown in FIGS. 2 to 4, the base plate aperture(s) 36 may be concentric with the corresponding locating protrusions 35. The base plate aperture 36 may be threaded. One or more boom apertures 60 may be provided in the first boom section 21, corresponding to the at least one base plate aperture 36. The one or more boom apertures 60 may be threaded.

The base plate 30 may be made from any suitable material, such as structural steel.

The wear pad 40 may extend across a thickness 41 between a coupling surface 42, which may face and be coupled to the base plate 30, and an opposing sliding surface 43, which may be configured for the second boom section 22 to slide therealong. Hence the wear pad 40 may be coupled to the base plate 30, and the second boom section 22 may be configured to slide relative to the first boom section 21 along the sliding surface 43 of the wear pad 40, particularly in the sliding direction 80. In the present disclosure the term “coupled” means two parts contacting each other, such as one part resting on another part, and does not connote or imply any form of attachment.

The wear pad 40 may be a plate and the dimensions across the coupling and/or sliding surfaces 42,43 may be substantially greater than the thickness 41. The wear pad 40 may be elongate along the sliding direction 80 as illustrated. The coupling and/or sliding surfaces 42,43 may be substantially rectangular and the wear pad 40 may be a substantially rectangular cuboid, although other shapes are possible. The shape and size of the wear pad 40 may generally correspond with the shape and size of the base plate 30, although this is not required.

The coupling surface 42 of the wear pad 40 may be provided with at least one recess 44 for engagement with the one or more locating protrusions 35 of the base plate 30. That is, the at least one recess 44 may be shaped and sized to fit around the one or more locating protrusions 35. As shown in in the specific embodiment shown in FIGS. 2 to 4, a single generally oval-shaped recess 44 may be provided, which may fit around the two spaced apart generally circular locating protrusions 35. Alternatively, a single recess 44 may be shaped to correspond with a single locating protrusion 35, two or more recesses 44 may be individually shaped to correspond with two or more locating protrusions 35, or one or more recesses 44 may each be shaped to fit around a two or more locating protrusions 35. The at least one recess 44 may be a blind recess, such that it does not penetrate through the thickness of the wear pad 40, as illustrated in the specific embodiment shown in FIGS. 2 to 4. Alternatively, the at least one recess 44 may be a through recess, such that it penetrates through the thickness of the wear pad 40.

The at least one recess 44 may be configured to provide a clearance fit with the one or more locating protrusions 35 of the base plate 30, such that the wear pad 40 may be assembled with the base plate 30 (and subsequently disassembled) without the need for force or the use of a tool. In particular, the at least one recess 44 may be shaped and/or sized to provide a clearance fit with the one or more locating protrusions 35 of the base plate 30. The term “clearance fit” is used herein to mean that the dimensions of a hole and a shaft are such that a clearance or gap exists between the hole and the shaft when they are assembled; that is to say, the hole is larger than the shaft. Thus the at least one recess 44 may be larger than the one or more locating protrusions 35 of the base plate 30.

One or more edges of the perimeter of the sliding surface 43 of the wear pad 40 may be provided with a chamfer 45. In particular, the two leading edges of the perimeter of the sliding surface 43 of the wear pad 40 (relative to sliding direction 80) may be provided with a chamfer 45, as illustrated in the specific embodiment of FIGS. 2 to 4. However, any number or all of the edges of the perimeter of the sliding surface 43 of the wear pad 40 may be provided with a chamfer 45. The chamfer 45 may aid in reducing friction by providing a transitional edge to the wear pad 40. The chamfer 45 may also serve as an indicator for monitoring the wear of the wear pad 40. For example, the wear pad 40 may be replaced when the sliding surface 43 of the wear pad 40 has worn away such that the chamfer 45 is no longer visible.

The wear pad 40 may comprise a suitable pad material for wearing away during use. The pad material may have a lower hardness than the boom sections 21,22 (14,15), such that the wear pad sacrificially wears away rather than the boom sections 21,22 (14,15). The pad material may, for example, comprise nylon.

One or more shims 50 may be provided for positioning between the base plate 30 and the wear pad 40. The one or more shims 50 may be identical to each other in all aspects other than thickness. Each shim 50 may be planar, having a length and a width that are substantially greater than its thickness. The shim 50 may have a substantially rectangular shape, as illustrated. Alternatively, the shim 50 may have a circular shape, a regular polygonal shape, or an irregular shape. The shape and size of the shim 50 may correspond to the shape and size of the base plate 30 and/or the wear pad 40, although this is not required. The shim 50 may be provided with a shim tab 52, which may extend in the plane of the shim 50 from one side of the shim 50. The size, shape, and/or location of the shim tab 52 on the shim 50 may correspond to the size, shape, and/or location of the base plate tab 34 on the base plate 30, such that the shim tab 52 may align with the base plate tab 34 when the shim 50 is stacked on top of the base plate 30.

The shim 50 may comprise at least one shim aperture 51 for engagement with the one or more locating protrusions 35 of the base plate 30. That is, the at least one shim aperture 51 may be shaped and sized to fit around the one or more locating protrusions 35. As shown in the specific embodiment of FIGS. 2 to 4, a single shim aperture 51 may be generally oval-shaped, and may fit around the two spaced apart generally circular locating protrusions 35. Alternatively, a single shim aperture 51 may be shaped to correspond with a single locating protrusion 35, two or more shim apertures 51 may be individually shaped to correspond with two or more locating protrusions 35, or one or more shim apertures 51 may each be shaped to fit around a two or more locating protrusions 35. The configuration of the at least one shim aperture 51 in the shim 50 may correspond to the configuration of the at least one recess 44 in the coupling surface 42 of the wear pad 40, such that the shim aperture 51 may align with the wear pad 40 recess 44 when the wear pad 40 is stacked on top of the shim 50.

The at least one shim aperture 51 may be configured to provide a clearance fit with the one or more locating protrusions 35 of the base plate 30, such that the shim 50 may be assembled with the base plate 30 (and subsequently disassembled) without the need for force or the use of a tool. In particular, the at least one shim aperture 51 may be shaped and/or sized to provide a clearance fit with the one or more locating protrusions 35 of the base plate 30. Thus the shim aperture 51 may be larger than the one or more locating protrusions 35 of the base plate 30.

The one or more shims 50 may be of equal thickness to each other. Alternatively, shims 50 of differing thicknesses may be provided.

The one or more shims 50 may be made from any suitable material. For example, the one or more shims 50 may be made from ‘shim steel’, which is a cold-rolled carbon steel tempered to a specified hardness range.

The wear pad assembly 20 may be assembled by locating the wear pad 40 on the base plate 30, such that the coupling surface 42 of the wear pad 40 contacts the first surface 32 of the planar element 31 of the base plate 30. The wear pad 40 is located on the base plate 30 by engaging the at least one recess 44 of the wear pad 40 with the one or more locating protrusions 35 of the base plate 30. If one or more shims 50 are required, the one or more shims 50 are positioned between the wear pad 40 and the base plate 30, such that both the coupling surface 42 of the wear pad 40 and the first surface 32 of the planar element 31 of the base plate 30 each contact a shim 50 surface. Each shim 50 may be oriented such that the shim tab 52 is aligned with the base plate tab 34.

A technician may measure the wear pad assembly 20 against the gap 23 between the first and second boom sections 21,22. If the wear pad assembly 20 does not substantially fill the gap 23, one or more shims 50 may be added between the base plate 30 and the wear pad 40. The optimal thickness of the wear pad assembly 20 may be such that, when the second surface 33 of the base plate 30 contacts the first boom section 21, a running clearance 53 is present between the sliding surface 43 of the wear pad 40 and the second boom section 22. The running clearance 53 may be set to avoid binding of the first and second boom sections 21,22 due to variation in the first and second boom sections 21,22 along the path of travel (that is, in the sliding direction 80). For example, if a running surface of the first or second boom section 21,22 has a flatness of 2 mm, the running clearance may be set to 3 mm.

When the desired thickness of the wear pad assembly 20 is achieved, the wear pad assembly 20 may be slid along a first side 25 of the first boom section 21, between the first and second boom sections 21, 22. The wear pad assembly 20 may be slid along the first side 25 of the first boom section 21 with the base plate tab 34 (and shim tab(s) 52 if present) nearest to a proximal end of the boom sections 21,22, such that the base plate tab 34 (and shim tab(s) 52 if present) may be used to facilitate adjusting the position of the wear pad assembly 20 between the boom sections 21,22.

The technician may adjust the position of the wear pad assembly 20 along the first side 25 of the first boom section 21 to visually align the boom aperture(s) 60 with the base plate aperture(s) 36. The wear pad assembly 20 may then be secured to the first boom section 21 by inserting a releasable fastener 61 through each boom aperture 60 in a direction from a second side 24 of the first boom section 21 (the second side 24 of the first boom section 21 opposing the first side 25 of the boom section 21) and into the aligned corresponding base plate aperture 36. Any suitable releasable fastener may be used. As shown in the specific embodiment of FIGS. 2 to 4, the fastener 61 may, for example, be a threaded bolt.

Thus the base plate 30, the wear pad 40, and any shims 50 (if present) are all located on the first side 25 of the first boom section 21, between the first boom section 21 and the second boom section 22. That is to say, the entire wear pad assembly 20 is positioned between the first boom section 21 and the second boom section 22. This excludes the fastener(s) 61, which are ancillary to the wear pad assembly 20.

In the assembled wear pad assembly 20 the wear pad 40, the base plate 30, and any shims 50 (if present) are not secured or attached to each other. The wear pad 40, the base plate 30, and any shims 50 (if present) contact and engage with each other but remain detached.

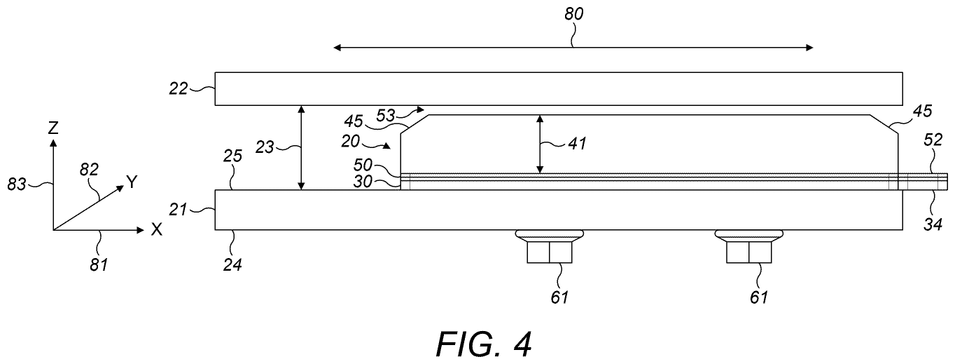

Although the wear pad 40, the base plate 30, and any shims 50 (if present) are not attached to each other, they are constrained in use in a Z-direction perpendicular to a plane of the planar element 31 (as indicated in FIG. 4) by and between the first and second boom sections 21,22. That is to say, the wear pad 40, the base plate 30, and any shims 50 (if present) are held captive in the Z-direction by and between the first and second boom sections 21,22. The at least one locating protrusion 35 and corresponding recess 44 and shim aperture 51 (as well as the releasable fasteners 61) constrain the wear pad assembly 20 in X-and Y-directions in the plane of the planar element 31 (as indicated in FIG. 4).

A strengthening plate (not shown) may be provided on the second side 24 of the first boom section 21 to strengthen the first boom section 21 in the region of the boom aperture(s) 60, the strengthening plate being provided with corresponding apertures. The strengthening plate may be non-releasably attached to the second side 24 of the first boom section 21, for example by welding.

In use, the thickness 41 of the wear pad 40 reduces due to the sliding contact of the second boom section 22 upon it. The wear pad assembly 20 may periodically be checked to monitor the wear of the wear pad 40. In the present disclosure the term “wear” refers to a reduction in thickness from an original, predetermined and pre-installation thickness due to sacrificial removal of the wear pad 40 material resulting from the sliding contact of the second boom section 22 upon the wear pad 40.

If the clearance between the installed wear pad 40 and the second boom section 22 increases beyond a predetermined size, the wear pad assembly 20 may be adjusted by adding one or more shims 50 to increase its thickness. First, the wear pad assembly 20 may be detached from the first boom section 21 by removing the fasteners 61. The wear pad assembly 20 may then be slid out from between the first and second boom sections 21,22. The base plate tab 34 (and shim tab(s) 52 if present) may aid in removing the wear pad assembly 20 from between the boom sections 21,22. The wear pad 40 may be lifted from the base plate 30, and one or more shims 50 may be added between the wear pad 40 and the base plate 30 to achieve the optimal thickness of the wear pad assembly 20. The adjusted wear pad assembly 20 may then be reinserted between the first and second boom sections 21,22 and secured by the fasteners 61. When the wear pad 40 reaches the end of its usable life, it can be replaced by a new wear pad 40 having the pre-installation thickness.

### INDUSTRIAL APPLICABILITY

By virtue of being able to adjust the thickness of the wear pad assembly 20 using one or more shims 50, the wear pad assembly 20 can be tailored to the required thickness to achieve an optimal running clearance between the first and second boom sections 21,22 for a particular telehandler. Furthermore, as the thickness 41 of the wear pad 40 reduces during the life of the wear pad 40, the thickness of the wear pad assembly 20 can be maintained by adding one or more shims 50, thereby prolonging the lifetime of the wear pad assembly 20 and thus reducing cost and waste.

Providing a clearance fit between the wear pad 40 and the base plate 30, and between the shim 50 and the base plate 30 reduces the complexity of assembling and disassembling the wear pad assembly 20. This is turn may reduce servicing time and thus servicing costs.

Locating the fastener(s) 61 outside of the load path may result in a hard joint that is resistant loosening. Again, this may reduce servicing requirements and thus costs.

1. A wear pad assembly for an extendable boom having a first boom section and a second boom section the wear pad assembly comprising:
a base plate for mounting to the first boom section the base plate comprising one or more locating protrusions and
a wear pad having a thickness extending between a coupling surface and an opposing sliding surface the coupling surface comprising a recess for engagement with the one or more locating protrusions of the base plate wherein the recess is configured to provide a clearance fit with the one or more locating protrusions of the base plate.

2. The wear pad assembly according to claim 1, wherein the recess is sized and/or shaped to provide the clearance fit with the one or more locating protrusions of the base plate.

3. The wear pad assembly according to claim wherein one or more edges of a perimeter of the sliding surface of the wear pad comprises a chamfer.

4. The wear pad assembly according to claim 1, wherein the base plate further comprises a base plate tab extending in a plane of the base plate from a side of the base plate.

5. The wear pad assembly according to claim 1, wherein the base plate further comprises at least one base plate aperture.

6. The wear pad assembly according to claim 5, wherein each base plate aperture extends through a locating protrusion of the one or more locating protrusions.

7. The wear pad assembly according to claim 1, further comprising one or more shims for positioning between the base plate and the wear pad each shim comprising a shim aperture for engagement with the one or more locating protrusions of the base plate.

8. The wear pad assembly according to claim 7, wherein the shim aperture is configured to provide a clearance fit with the one or more locating protrusions of the base plate.

9. The wear pad assembly according to claim wherein the shim aperture is sized and/or shaped to provide a clearance fit with the one or more locating protrusions of the base plate.

10. The wear pad assembly according to claim 7, wherein each shim comprises a shim tab extending in a plane of the shim from a side of the shim.

11. The wear pad assembly according to claim 7 wherein the shim tab is aligned with the base plate tab when the shim is located on the base plate.

12. The extendable boom having a first boom section and a second boom section the extendable boom comprising a wear pad assembly according to claim 7.

13. The extendable boom according to claim 12, wherein the wear pad assembly is mounted to the first boom section and the second boom section is configured to slide relative to the first boom section along the sliding surface of the wear pad.

14. The extendable boom according to claim 12 wherein the entire wear pad assembly is located between the first boom section and the second boom section.

15. The extendable boom according to claim 12, wherein the wear pad and the base plate are constrained in a direction perpendicular to a plane of the first boom section by the first boom section and the second boom section.

16. A telehandler comprising an extendable boom according to claim 12.
